(19) United States
(12) Patent Application Publication
(10) Pub. No.: US 2004/0214943 A1
(43) Pub. Date: Oct. 28, 2004

(54) Superabsorbent coatings for cellulosic materials

(76) Inventors: Thomas P. Hager, Columbus, OH (US); James R. Priest, Nashport, OH (US)

Correspondence Address: OWENS CORNING, 2790 COLUMBUS ROAD, GRANVILLE, OH, 43023, US

(21) Appl. No.: 10/813,934

(22) Filed: Mar. 31, 2004

Related U.S. Application Data
(63) Continuation-in-part of application No. 09/409,457, filed on Sep. 30, 1999.
Application No. 09/409,457 is a continuation-in-part of application No. 09/190,866, filed on Nov. 13, 1998, now Pat. No. 6,380,298.

(51) Int. Cl. B32B 3/00

(52) U.S. Cl. 524/507; 524/556

(57) ABSTRACT

Articles having superabsorbent, water-swellable polymers that absorbs water to provide the water-retention effect, and desorbs water when the coating is dried. The superabsorbent polymer is formed by applying an aqueous precursor composition including a an aqueous solution of a superabsorbent water-soluble polymer precursor, a binder, optionally a viscosity modifying agent, and optionally a lubricant onto the surfaces of the article, and curing to form a superabsorbent polymer.

### Cross-Reference to Related Patent Applications

This application is filed as a continuation-in-part of application Ser. No. 09/409,457, filed Sep. 3, 1999 which is a continuation-in-part of U.S. patent application Ser. No. 09/190,866, filed Nov. 13, 1998, (now U.S. Pat. No. 6,380,298) both of which are incorporated by reference in their entirety.

### TECHNICAL FIELD AND INDUSTRIAL APPLICABILITY OF THE INVENTION

The present invention relates to a superabsorbent polymer material capable of rapidly absorbing water formed from an aqueous precursor composition which is suitable for coating a variety of articles requiring a water-absorbing surface, including, but not limited to, cellulosic products. More specifically, the superabsorbent polymer is formed from an aqueous precursor composition comprising an aqueous solution of water-soluble superabsorbent polymer precursor and a binder. The superabsorbent polymer precursor, upon curing, forms a superabsorbent polymer material with a high water swelling ability. The aqueous precursor composition may further include additives such as a film-forming polymer, a viscosity-modifying agent, a lubricant and/or an optical brightener.

The superabsorbent polymer material of this invention demonstrates a high level of water absorption. The aqueous precursor composition has excellent spreading and coating ability when applied to a substrate. The aqueous precursor composition has a low viscosity (non-pasty) and may be easily applied to a substrate using a variety of techniques.

### BACKGROUND OF THE INVENTION

Currently, superabsorbent coatings used in the paper and pulp industry include solid materials to achieve water absorbable or water swellable properties in the final product. Some examples are specially treated cellulosic fibers or superabsorbent fibers or powders. The cellulosics do not have the water absorbing or more importantly, the water-retaining properties of superabsorbent powders.

Traditional uses for dry superabsorbent polymers have primarily included personal hygiene product articles, food packaging articles and chemical spill cleanup compositions. The swelling ability is directly related to the degree of cross-linking of the superabsorbent polymer. As the degree of cross-linking increases, so does the gel strength. However, there is a related decrease in the swell rate and swell capacity of the polymer. The swell rate defines the amount of water that the coating absorbs over a fixed period of time. The swell capacity denotes the maximum amount of water or fluid absorbed by the coating, based on a measure of its dry weight. Consequently, coatings made of dry, granular, water-insoluble polymer are limited in their water-absorbing performance, as measured in terms of the swell rate and swell capacity.

Generally, coatings that are made from powder materials are applied to the surface of the fibrous material and then cured before further processing, if any, occurs. One problem with powders is that they are difficult to process and difficult to hold in place in the finished article. Powder handling requires specific equipment to apply. The powders are not appropriate for use in some articles that would benefit greatly from having superabsorbent qualities, such as consumer and industrial paper toweling.

The means of applying these coatings, in general, differs depending on whether a fluid coating is used or whether a solid particulate coating is being applied. In the case of powdered coatings, the coating process using granulated water-blocking agents involves several time consuming and labor and equipment intensive steps that are directly related to the use of a granulated polymer. These steps include the need for one or more treatments with a binding resin, and one or more applications of powdered resin at the powder-coating stations using an apparatus such as a fluidized bed.

Traditionally in the art, in order to modify the viscosity of the fluid coating composition, dry particulate ingredients such as a flocculent polymer or starch have been used. The difficulty with such compositions is that the resulting composition after this solid ingredient is added is not homogenous. Rather, the composition contains varying levels of a particulate material, which makes handling difficult and also compromises the spreadability of the composition.

The coating may be sprayed onto the surface of the article. In order to form a coating layer that provides good coverage and exposure to water, the coating composition must flow easily and adequately coat the article in one pass through the coating apparatus. Sufficient flowing ability allows ready formation of a uniform coating on the surface of the article, and prevents clogging of the coating apparatus. Further, the coating must be fast-drying, especially where paper products are produced at high rates of speed.

WO 96/23024 discloses a composition containing monomers which polymerize in the presence of a catalyst to obtain a polymeric, pasty solution. The pasty material is applied as semi-spherical islets to a substrate. The pasty material also contains a thermally-activatable cross-linking agent to facilitate cross-linking of the polymer chains when the coated substrate is dried. The composition on the substrate is dried between 1 and 3 minutes at relatively high temperatures (150° C. to 200° C.) to activate the cross-linking agents.

U.S. Pat. No. 4,354,487 discloses a process form preparing absorbent polymer fibers including applying a solution including acrylic acid to an aggregation of fibers, irradiating the solution to convert the salt of the acrylic acid to a water-swellable polymer, dispersing the fibers and finally collecting the fibers in the form of a fluffy bat of fibers having isolated portion of water-swellable polymer affixed to individual or small groups of fibers.

U.S. Pat. No. 5,567,478 discloses a process for producing a water-absorbing sheet material. A fabric is impregnated with a solution including partially neutralized acrylic acid and a cross-linking agent. The monomer solution is polymerized by the presence of non-thermally activatable radical initiators and one thermally activatable radical former.

U.S. Pat. Nos. 6,133,369 and 6,013,325 disclose a printable, swellable paste containing polymers having carboxyl and amide group moieties and an aldehyde. Cross-linking of the polymer occurs by free-radical reactions which occur by thermally treating the polymer.

There is a need for a low-viscosity, fast-drying, aqueous precursor composition for application to cellulosic products which, when cured for form a superabsorbent polymer material, possesses excellent wicking ability, as well as a high degree of water absorption and a concurrent, rapid swell rate. At the same time, a further need exists in the art for an aqueous precursor composition that does not contain powdered polymer or additional cross-linking agents and which, as a result, would not require a costly and/or labor intensive application process.

Moreover, it is desired that such an aqueous precursor composition be non-pasty and exhibit good spreading and surface performance characteristics as well as have a short curing time. Further it is desired that the aqueous precursor composition have a long shelf-life so that the coating may be shipped and/or stored for subsequent use.

### SUMMARY OF THE INVENTION

It has been discovered that aqueous, low-viscosity, precursor compsotions which, when cured to form a superabsorbent polymer material, have an excellent water swelling capacity, a rapid swell rate and can be formed by incorporating an aqueous precursor composition of a water-soluble superabsorbent polymer precursor used to coat paper and other cellulosic products, i.e., paper towels. The water-soluble polymer precursor, when cured, forms a superabsorbent polymer without the addition of cross-linking agents. The superabsorbent polymer materials containing this water-soluble superabsorbent polymer are capable of substantially instantaneous water absorption when exposed to aqueous environments.

Depending on the intended application, the aqueous precursor composition may be enhanced by adding additional additives such as a viscosity-modifying agent, a lubricant, a wetting agent and/or optical brighteners.

This invention also relates to an article coated with an aqueous precursor composition which is then cured to form a superabsorbent polymer material. The articles include mats, fabrics, laminates, scrims, personal hygiene products, wood and paper products, and construction materials. Generally, this process includes the steps of applying the aqueous precursor composition on the article, followed by a drying or curing step.

### DETAILED DESCRIPTION OF THE PREFERRED EMBODIMENTS OF THE INVENTION

The aqueous precursor composition of this invention is suitable for forming a superabsorbent polymer on the surface of articles or materials requiring surfaces that require water absorbance.

The term “article”, as it is used herein, is specifically intended to include any product or material having a surface that requires water-absorbing properties to enhance the function and performance of the underlying structure by exposure to moisture.

In the manufacture of disposable absorbent articles, the aqueous precursor composition may be applied to an absorbent core substrate, namely nonstabilized cellulosic fibers, nonwoven or woven web, in liquid form in a single step operation, thus resulting in a more uniform and consistent layer of absorbent polymer onto the fibers or into the web. Upon drying, the polymer may form a continuous film layer or an interpenetrating network depending on the viscosity of the aqueous precursor composition and the porosity of the substrate to which the aqueous precursor composition is being applied. Disposable absorbent articles include disposable diapers, sanitary napkins, bandages, wound care products, surgical pads, drapes and gowns as well as various paper products such as paper towels, particularly multiple use towels, toilet paper, facial tissue and the like.

The aqueous precursor composition may be applied to a fiber to increase the hygroscopicity/humectancy (hydrophilicity) or for the purpose of manufacturing superabsorbent fibers having enhanced absorbent properties. Examples of useful fibers include natural cellulose fibers such as wood pulp, cotton, silk and wool; synthetic fibers such as nylon, rayon, polyesters, acrylics, polypropylenes, polyethylene, polyvinyl chloride, polyurethane, glass and the like, alone or in combination with one another. In the case of absorbent cores, the fiber layer often contains at least 50% natural and/or synthetic cellulose fibers. The superabsorbent fibers produced may be used in many applications including absorbent cores in disposable absorbent products, as well as absorbent products such as paper towels, facial tissue, toilet paper, meat-packing absorbents, etc.

Further, a self-supporting superabsorbent web may be formed by applying a sufficient amount of the aqueous precursor composition to a web of fibers. The starting fiber layer or mass can be formed by any one of the conventional techniques for depositing or arranging fibers in a web or layer. These techniques include carding, garnetting, air-laying, wet laying and the like and are well known to those skilled in the art. Individual webs or thin layers formed by one or more of these techniques can also be laminated to provide more loft and caliper. Typically, the fibers extend in a plurality of diverse directions in general alignment with the major plane of the fabric, overlapping, intersecting and supporting one another to form an open, porous structure.

The water-swellable properties of the superabsorbent polymer of the present invention are obtained by combining a solution of a non-toxic, environmentally safe aqueous solution of water-soluble polymer precursor with the binder resin used to coat the substrate articles. The aqueous precursor composition, when cured to form a superabsorbent polymer, possesses a surprisingly high capacity for absorbing water, and at the same time maintains a high gel strength in the cured coating as a result of controlled cross-linking. As mentioned previously, this polymer uniquely provides water absorbance by swelling and retaining large quantities of water. As water contacts the coated surface of the article, the coating absorbs water and swells in volume. By absorbing the water at a high rate of uptake, the coating effectively enhances the substrate material to hold large quantities of water as measured by percent weight increase of the substrate.

The non-toxic, environmentally safe superabsorbent polymer precursor used in the coatings of this invention may be selected from any such polymer capable of forming an aqueous solution for use in the coating mixture, and which, upon cure, has a swell capacity and swell rate that enables rapid absorption of large amounts of water followed by desorption without loss of the polymer itself when the coating is dried. A polymer precursor suitable for use in the present coating will demonstrate a swell capacity of up to about 800 times its initial dry weight when the coating is applied to articles and cured.

The superabsorbent polymer precursor for use in the present invention may, for example, be selected from chemical precursors to water-soluble polyacrylates which, upon cure, possess the required ability to absorb and desorb large quantities of water, as has been previously mentioned. The superabsorbent polymer precursor is preferably used in its anionic form as a salt of a corresponding alkali or alkali metal salt. The polymer salt is in the form of an aqueous solution that is either clear or slightly cloudy in appearance. The desirable solids content is in the range of from 30-35% weight. The solution also has a specific gravity of about 1.1 grams per milliliter. The solution is typically slightly anionic, having a pH of from about 6 to about 8. One example of an acceptable superabsorbent polymer precursor is a water-soluble anionic polyacrylate in aqueous solution. It is conceivable that coatings comprising the high swelling superabsorbent polymer of the present invention would absorb significantly higher quantities of water, demonstrating swell rates up to and including 800 times the dry weight.

A viscosity-modifying agent may also be added to the coating composition. The role of this viscosifier is to create a spreading consistency that will enable adequate coating of the article. Therefore, the viscosity should be sufficient to provide good flowing ability and to prevent clogging of the coating apparatus and die orifices. The viscosity-modifying agent is not an insoluble powdered component, rather it is a polymeric solution or dispersion that can be easily incorporated into the coating composition. Hence, unlike superabsorbing coatings previously known in the art, the coating composition of this invention is in the form of a true solution having substantially no particulate components.

As noted above, the aqueous precursor composition of the present invention is non-pasty. The viscosity of the coating is under about 500 centipoise and preferably under about 50 centipoise at about 20° C. The viscosity of the aqueous precursor composition can be modified depending on the article that is to be coated. The viscosity modifier can be added to the coating to increase the viscosity of the composition. This is particularly advantageous in processing when it is desirable to have a viscous coating to prevent splashing, i.e., during application or when applying the coating as a surface treatment.

Viscosity modifying agents capable of forming a true solution, such as alkyl cellulose, acrylic latex or acrylamide polymers, may be used in the coatings of this invention. A preferred viscosifier for use in the present coatings is a polyacrylamide in aqueous solution. The polyacrylamide solution is particularly suitable because of its compatibility with the superabsorbent polymer precursor solution and the film-forming binder component.

The binder component used in the aqueous precursor compositions of this invention can include any polymeric material customarily used as a binder in coating compositions for cellulosic products. Standard binders in the paper processing industry include starches, acrylic latexes and ethylene vinyl acetate (EVA) latex. The binder can also be a film-forming polymer or polymer latex that is a thermosetting resin or a thermosetting resin with some thermoplastic properties to enhance the flexibility of the coating. The film-forming binder is also necessarily compatible with the water-absorbing polymer and with the viscosity-modifying agent, in that it promotes combination of the ingredients in the coating composition, and also facilitates adherence of the coating to the surface once it is applied. The film-former further provides a tough film with preferably no surface tackiness or flaking of the coating after it is cured. The film-forming polymer comprised in the binder may for example be a polyester, urethane, epoxy, latex or mixtures thereof. The latex may in turn be selected from an acrylic latex, a styrene-butadiene latex, or mixtures thereof. Preferably, the binder is a film-forming urethane that promotes adherence of the water-absorbing polymer to the treated surface after it is dried. An example of a desirable film-forming binder is Witcobond W320, which is a polyurethane film-former available from Witco Chemical Co.

Optionally, the coating composition may also include one or more additives selected from the group consisting of lubricants, wetting agents and optical brighteners.

When the aqueous precursor compositions of the invention are applied to the surfaces of articles and cured, they demonstrate a swell capacity of up to about 800 times the initial dry weight of the water-swellable polymer. The swell capacity can be adjusted and controlled by varying the amount of superabsorbent polymer precursor in the composition. The amount of the aqueous precursor composition applied to the article can also control the swell capacity as well as the swell rate. For example, adding more superabsorbent polymer precursor to the composition or coating the majority of the surface of the article with the aqueous precursor solution will increase the swell capacity of the superabsorbent polymer material.

Depending on the swell capacity and swell rate desired, the aqueous precursor composition may be applied to all of or a part of the article. For the purposes of the invention, the term “applied to” means that the aqueous precursor composition is affixed to at least a portion of the article including: 1) covering at least a part of it, 2) being partially absorbed into at least a part of it, 3) being partially adsorbed on at least part of it, or 4) otherwise contacting or binding to at least a part of a) the external aspects of the article, b) the internal aspects of the article, or c) both. The term includes instances where the external aspects of the article, the internal aspects of the article or both are completely covered and/or filled with the aqueous precursor composition.

In many applications, it is advantageous for the swell rate of the superabsorbent polymer to be high. The superabsorbent polymers of this invention demonstrate an exceptionally high swell rate, in the order of from about 50 grams water to about 340 grams (about 300% to about 2000%) weight in the first minute, based on the total weight of the polymer and the substrate, where deionized water is used for example, to simulate a fresh-water environment. The swell rate may vary slightly from this range depending on the presence of ionic species or other additives in various fresh water environments. However, generally, in fresh water, the swell rate is higher than can be achieved in a saline solution such as a marine environment. In a saline environment, for example, the rate of water uptake varies depending on the salinity of the aqueous environment in which the superabsorbent polymer is used. Typically, the superabsorbent polymer of the invention demonstrate an absorbency of between about 33 grams salt water per gram and about 66 grams salt water per gram (about 300% to about 760%), in the first minute. However, whether the superabsorbent polymer is used in either a fresh or salt-water environment, its performance, as measured by the swell rate, is demonstrably higher than has been previously achieved by dry water swellable coatings known in the art. In a preferred embodiment, the water swellable, superabsorbent polymer of the invention has the ability to absorb either about 126 grams of deionized water per gram of dry coating, or about 50 grams of salt water per gram of dry coating, in the first minute of exposure.

In making the superabsorbent polymer of this invention, the ingredients are combined in liquid form to prepare the aqueous precursor composition. An aqueous solution of the superabsorbent polymer precursor is first stirred to ensure homogeneity, and then added to a mixing tank. Deionized water is then added to the tank, and the lubricant, if desired, is then introduced. Next, the polyurethane in the form of an aqueous emulsion is pumped into the tank. The viscosity-modifying agent, if desired, is first premixed to form a 1% wt. aqueous solution, and a sufficient amount of this aqueous solution is added to the mixing tank. As a final step, the mixture is then stirred, without heating, and the resulting composition is ready for application.

The aqueous precursor composition is contacted with the surface of the articles to be coated by a means suitable for applying a liquid coating. For example, the aqueous precursor composition can be added to a substrate such as paper during manufacturing. An advantageous step to add the coating in the paper-making process is after the paper is formed on the wire but before the paper is consolidated between squeeze rollers. The paper is then dried by passing the continuous paper sheet over and under a series of steam-heated drums. The aqueous precursor composition could saturate the paper substrate by means of a curtain coater or by spraying the coating onto the sheet. Saturating the cellulose fibers that comprise the paper substrate with the coating composition would increase the surface area of the aqueous precursor composition. This in turn greatly enhances the superabsorbent polymer (once cured) to absorb large quantities of water very quickly. However, as is typical in the paper making process, a more practical step to coat the paper would be after the paper is dried during the conventional coating step. Since paper is weakened when re-wet, the coated sheet could be passed through a gas-IR oven to effectively and quickly dry and cure the coating. Speeds of 1,000 f/min can be achieved if the oven is properly configured.

Alternatively, the aqueous precursor composition is applied to an article to be coated by spraying, flooding, dipping, padding, brushing, electrostatic application or by any other means which permits the liquid coating to be contacted with the surface or a partial surface of the article. A further processing means may then be used to ensure an even and adequate distribution of the coating layer.

The coated articles are then dried and cured. By balancing line speed, oven length or number of heated drums, and oven or heated drum temperatures, the article, coated with aqueous precursor composition, is in practice heated to between about 125° C. to about 140° C., preferably about 138° C., to cure the polymer by cross-linking. Typically, polymers heated to above approximately 300° F. (149° C.) lose the desired superabsorbent quality. The coated article can be cured in under approximately seven seconds to several minutes depending on the processing time, i.e., machinery. The cure time of the coating composition can also be used to control the swell rate of the composition. For example, increasing the cure time of the aqueous precursor composition will decrease the swell rate of the superabsorbent polymer by increasing the cross-linking density of the polymer. In the alternative, decreasing the cure time of the aqueous precursor composition will increase the swell rate of the superabsorbent polymer. The drying/curing step may be performed as described earlier, by either passing the wet paper substrate saturated with the aqueous precursor composition over and under a series of heated drums, for example, of from 25 to 50 or more depending on the line speed and the temperature of the drums. A preferable method of drying and curing would be to use a non-contact heat source such as a gas-IR oven. Given sufficient length and temperature of the IR elements, line speeds of 1,000 f/min or more could be readily achieved.

As mentioned, cross-linking agents, i.e., catalysts are not required for the cross-linking of the polymer. The aqueous precursor composition is autocatalytic and cross-linking occurs via monomer units incorporated into the polymer precursor backbone reacting with one another. An example of this could be an acrylamide monomer unit copolymerized into the chain of the polymer backbone reacting and cross-linking with a methylolacrylamide monomer unit copolymerized into a different section of the polymer backbone that happens to be twisted back next to the first unit. The polymer backbone is further comprised of alkali metal salts or ammonium salt of acrylic acid monomer units copolymerized into the backbone.

Superabsorbancy occurs when water comes into contact with and solvates the cation away from the anion (the carboxylic group.) The remaining bound, negatively charged carboxyl groups on opposing polymer sections strongly repel each other. This forces the cross-linked polymer to expand, exposing new carboxylic salt groups in the interior of the tightly wound polymer chain to now be exposed to water. This process continues until the polymer is fully saturated and distended, holding a disproportionately large volume of water.

The aqueous precursor composition of the present invention has a shelf life of approximately six to twelve months. The term “shelf life”, for the purposes of this invention, is defined as, the time when the aqueous precursor composition begins to stratify and separate which occurs over a period of time. The aqueous precursor composition also increases in viscosity and resist being mixed into a homogeneous composition. This may be a result of slow reaction of the components and an increase of molecular weight to the point the aqueous precursor composition can no longer stably be suspended in water. Also, evaporation, exposure to oxygen, or mold and bacteria degradation can also play a role in the aging of the aqueous precursor composition. Although the composition can still be dried and cured and exhibit water absorbency, the process efficiency diminishes with time and can no longer be practically applied.

The aqueous precursor composition formulations are prepared by combining a film-forming binder polymer, and a water-absorbing polymer precursor solution. Preferably, about 30% to about 95% by weight, more preferably about 50% to about 90% by weight, most preferably about 75% to about 85% by weight, all amounts based on a dry solids basis, of a superabsorbent polyacrylate precursor solution (aqueous), such as that available commercially as Stockhausen Cabloc FL from Stockhausen Inc. or Product XP-99.01 from Emerging Technologies Inc. (ETI) and preferably about 1% to about 30% by weight, more preferably about 5% to about 20% by weight, most preferably about 10% to about 18% by weight, all amounts based on a dry solids basis, of a film former, preferably a urethane film-forming polymer such as Witcobond W290H, available from Witco Chemical Co.

Optionally, a viscosity modifying agent may be added to the aqueous precursor composition, preferably about 0% to about 5% by weight, more preferably about 0% to about 3% by weight, most preferably about 0% to about 2% by weight, all amounts based on a dry solids basis. Preferably, the viscosity modifying agent is an aqueous acrylamide solution, Drewfloc 270, which is available commercially from Ashland Chemical Inc.

A lubricant may also be added to the aqueous precursor composition, preferably about 0% to about 20% by weight, more preferably about 0% to about 10% by weight and most preferably about 0% to about 7% by weight, all amounts based on a dry solids basis. Preferably the lubricant is a mineral oil lubricant such as Emerlube 7440 available from Henkel Corp.

The coating composition may also contain an optical brightener such those which are commonly known in the cellulosic products industry. The amount and type of optical brightener added depends on the product and the degree of whiteness desired. Optical brighteners which are non-ionic and stable at acidic pH are preferred so that they may be evenly dispersed throughout the aqueous precursor composition. Such an optical brighteners include copper phthalocyanine and are added to the aqueous precursor composition in the amount of about 0 to about 3% by weight, based on a dry solids basis.

It is believed that Applicants' invention includes many other embodiments which are not herein specifically described, accordingly this disclosure should not be read as being limited to the foregoing examples or preferred embodiments.

1. An aqueous precursor composition for forming a superabsorbent polymer comprising:
1) an aqueous solution of water-soluble superabsorbent polymer precursor;
2) a binder; and
3) an optional viscosity modifying agent.

2. The composition of claim 1, wherein the viscosity of said aqueous precursor composition is less than about 500 centipoise at 20° C.

3. The composition according to claim 1, wherein said aqueous precursor composition is autocatalytic.

4. The composition according to claim 2, wherein the viscosity of said aqueous precursor composition is less than about 50 centipoise at 20° C.

5. The composition of claim 1, wherein said aqueous precursor composition has a shelf-life of between about 6 to about 12 months.

6. The composition of claim 1, wherein said water-soluble superabsorbent polymer precursor is a water-soluble polyacrylate.

7. The composition is claim 6, wherein said water-soluble superabsorbent polymer precursor is in its anionic form as a salt of a corresponding alkali or alkali metal salt.

8. The composition of claim 1, further comprising a lubricant.

9. The composition of claim 6, wherein said aqueous precursor composition comprises between about 30 to about 95 percent by weight of said water-soluble polyacrylate.

10. The composition of claim 8, wherein said aqueous precursor composition comprises between about 0 to about 20 percent by weight of said lubricant.

11. The composition of claim 1, wherein said binder is a polyurethane.

12. The composition of claim 1, wherein said aqueous precursor composition comprises between about 1 to about 30 percent by weight of said binder.

13. The composition of claim 1, wherein said viscosity modifying agent is an aqueous polyacrylamide solution.

14. The composition of claim 1, wherein said aqueous precursor composition comprises between about 0 to about 5 percent by weight of said viscosity modifying agent.

15. The composition of claim 1, wherein said aqueous precursor composition further comprises an optical brightener.

16. An article having a superabsorbent polymer comprising:
a) an article;
b) an aqueous precursor composition applied to said article; said aqueous composition comprising:
1) an aqueous solution of a water-soluble superabsorbent polymer precursor;
2) a binder; and
3) an optional viscosity modifying agent;
wherein the viscosity of said aqueous precursor composition is under about 500 centipoise at 20° C., wherein said aqueous precursor composition is cured on said article to form said superabsorbent polymer on said article.

17. The article according to claim 16, wherein said article is selected from the group of articles consisting of tapes, mats, fabrics, laminates, scrims, wood and paper products, and construction materials.

18. The article according to claim 17, wherein said article is a cellulosic material.

19. The article according to claim 16, wherein said article is selected from the group consisting of disposable diapers, sanitary napkins, bandages, wound care products, surgical pads, drapes, gowns, paper towels, multiple use towels, toilet paper, facial tissue towels, sheets and personal hygiene products,

20. The article according to claim 16, wherein said superabsorbent polymer absorbs water when immersed in an aqueous environment and desorbs said water when said coating is dried.

21. The article according to claim 16, wherein said superabsorbent polymer absorbs up to about 800 times its initial dry weight in water when immersed in an aqueous environment and desorbs said water when said coating is dried.

22. The article according to claim 16, wherein said aqueous precursor composition is autocatalytic.

23. The article according to claim 16, wherein the viscosity of said aqueous precursor composition is less than about 50 centipoise at 20° C.

24. The article according to claim 16, wherein said aqueous precursor composition further comprises an optical brightener.

25. The article according to claim 16, wherein said aqueous precursor composition has a shelf-life of between about 6 to about 12 months.

26. The article according to claim 16, wherein said water-soluble superabsorbent polymer precursor is a water-soluble polyacrylate.

27. The article according to claim 26, wherein said water-soluble superabsorbent polymer precursor is in its anionic form as a salt of a corresponding alkali or alkali metal salt.

28. The article according to claim 16, wherein said aqueous precursor composition further comprises a lubricant.

29. The composition of claim 28, wherein said aqueous precursor composition comprises between about 30 to about 95 percent by weight of said water-soluble polyacrylate.

30. The composition of claim 28, wherein said aqueous precursor composition comprises between about 0 to about 20 percent by weight of said lubricant.

31. The composition of claim 16, wherein said binder is a polyurethane.

32. The composition of claim 16, wherein said aqueous precursor composition comprises between about 1 to about 30 percent by weight of said binder.

33. The composition of claim 16, wherein said viscosity modifying agent is an aqueous polyacrylamide solution.

34. The composition of claim 16, wherein said aqueous precursor composition comprises between about 0 to about 5 percent by weight of said viscosity modifying agent.
